(19) United States
(12) Patent Application Publication
(10) Pub. No.: US 2026/0227188 A1
(43) Pub. Date: Aug. 6, 2026

(54) SYSTEM AND METHOD FOR NAVIGATING AND INTERACTING VIA CONVERSATION

(71) Applicant: Carnegie Mellon University, Pittsburgh, PA (US)

(72) Inventors: Oscar J. Romero-Lopez, Pittsburgh, PA (US); Anthony Tomasic, Pittsburgh, PA (US); John D. Zimmerman, Pittsburgh, PA (US); Aaron Steinfeld, Pittsburgh, PA (US)

(73) Assignee: Carnegie Mellon University, Pittsburgh, PA (US)

(21) Appl. No.: 19/155,311

(22) PCT Filed: Feb. 19, 2024
(86) PCT No.: PCT/US2024/016377

§ 371 Date: Aug. 11, 2025

Related U.S. Application Data
(60) Provisional application No. 63/446,656, filed on Feb. 17, 2023.

(51) Int. Cl. G01C 21/20; G06F 3/16

(52) U.S. Cl. CPC G01C 21/206; G06F 3/167

(57) ABSTRACT

A system and method can be used by blind and low-vision users to navigate and interact in an environment using conversational speech. The system and method integrate object detection, spatial anchors, and conversation to support both independent navigation and interaction. Object detection can be accomplished by capturing data from sensors on an electronic device carried by the user. Spatial anchors can include information relevant to requests from the user. The use of conversational speech permits an exchange of information that is not cognitively overwhelming.

### CROSS-REFERENCE TO RELATED APPLICATIONS

This application claims the benefit under 35 U.S.C. § 119 of U.S. Provisional Application Ser. No. 63/446,656, filed on Feb. 17, 2023, which is incorporated herein by reference.

### STATEMENT REGARDING FEDERALLY SPONSORED RESEARCH

This invention was made with United States government support under 90DPGE0003 and 90REGE0007 awarded by the United States Department of Health and Human Services. The government has certain rights in the invention.

### BACKGROUND OF THE INVENTION

The present disclosure generally relates to systems and methods to assist individuals navigating a space. More specifically, the disclosure relates to systems and methods that can be used to assist sighted users but also blind and low-vision users in navigating their environment through conversational interaction with an electronic device.

When a person navigates new spaces, the process inherently involves path planning, hazard avoidance, and just-in-time information delivery. Interaction involves recognizing interactive features and objects, creating mental models of where objects are located, understanding a set of visual choices, making selections, and understanding feedback that can often be visual. For many people, these tasks are based on visual acquisition of information about the space. In turn, public spaces are often designed to assist visual navigation and interaction. For example, a shopping mall will have a variety of signs indicating the location of restrooms and exits. Or a crosswalk will be marked with lines and electronic signage will indicate when it is safe to cross.

Some sighted people, and people who are blind or low-vision, struggle to navigate new indoor spaces and to effectively interact with objects and situations they encounter as they must rely on non-visual information. In the example of the crosswalk, an audio cue may be provided in addition to the signage. However, not all objects or environments have these additional modes of providing information. For example, attending a conference requires a person to navigate the venue, find the desired room, and discover and approach a microphone to ask a question. These types of tasks are rarely designed with blind and low-vision users in mind. In a complex space, sighted people also struggle with these tasks.

Some emerging technologies can provide a more sophisticated solution to the navigation and interaction problem for blind and low-vision users. Some of the technologies include augmented reality (AR), high-precision indoor localization, conversational systems, scene understanding, and real-time object detection. AR provides a new channel of information by placing markers in the environment (spatial anchors) that hold virtual content and contextual information, thereby enhancing both navigational and object interaction experiences. Conversational interaction allows people to engage with a navigation system, inquire about their environment, and learn about things they might want to interact with. However, with all of these systems, it can be difficult to provide information in a manner that is useful to users without being cognitively overwhelming.

Therefore, it would be advantageous to develop a system to assist with navigation and interaction that enhances accessibility and supports independence for all people.

### BRIEF SUMMARY

According to embodiments of the present disclosure is a smartphone-based, indoor navigation via a conversational assistant for people who are blind or low-vision. Prior systems relied on less accurate and more expensive technologies, such as hardware beacons, to provide indoor localization. Moreover, prior systems lacked cohesive integration of both navigation and object interaction, requiring users to utilize separate applications for each function. The present system utilizes a cognitive architecture to integrate three different technologies: real-time object/people detection for obstacle avoidance and discovery; augmented-reality spatial anchors for high precision localization and virtual content interaction; and large language models (LLMs) for information extraction, conversational interaction, scene understanding, and turn-by-turn navigation.

Conversational interaction allows people to engage with a navigation system, inquire about their environment, and learn about things they might want to interact with. Conversation makes a new type of user experience possible for people who are blind and low-vision, enhancing accessibility and supporting independence. This benefit can be extended to other uses as well, such as users who are cognitively impaired or otherwise have difficulty utilizing smartphone-based applications. Object detection provides a new dimension for understanding dynamic aspects of the environment. It can help people avoid hazards such as construction work, low overhanging obstructions, crowds, and other navigational difficulties. In this manner, conversation helps holistically integrate disparate technologies to deliver a better, more context-aware user experience while remarkably reducing task completion time.

### BRIEF DESCRIPTION OF THE SEVERAL VIEWS OF THE DRAWINGS

FIG. 1 is a diagram of the system, according to one embodiment.

FIG. 2 is a diagram of the system according to an alternative embodiment.

### DETAILED DESCRIPTION

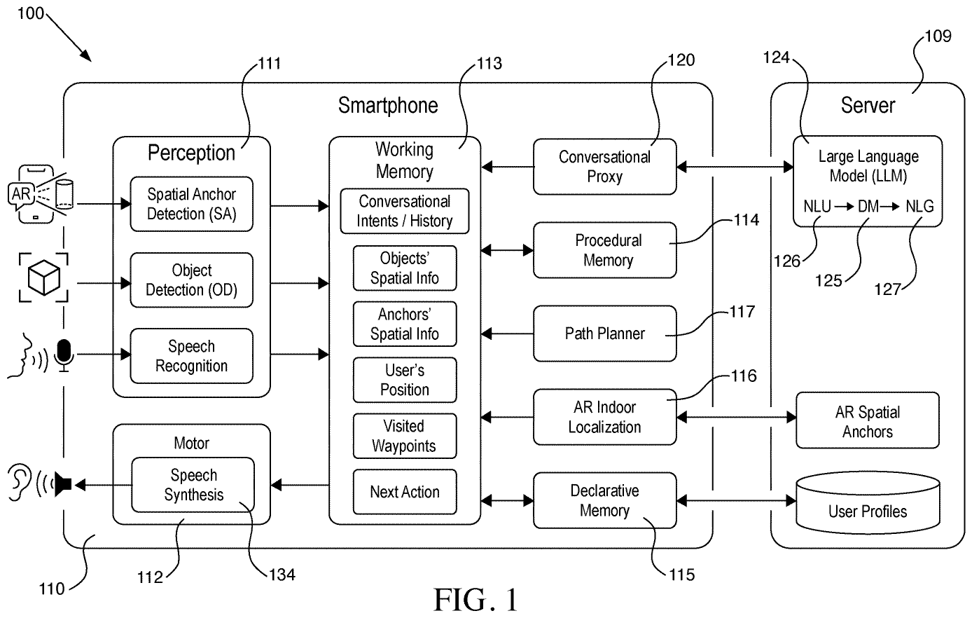

According to embodiments of the disclosure is a system that effectively integrates object detection, spatial anchors, and conversation to support both independent navigation and interaction. The integration of conversational wayfinding and discovery greatly enhances the usability for blind and low-vision users as well as for users who may suffer from cognitive impairment. FIG. 1 shows the system 100 implemented in a client-server architecture. On the client side, and electronic device 110 (i.e. a smartphone) executes several modules running asynchronously on separate threads. The modules may include a perception module 111, a motor module 112, a working memory module 113, a procedural memory module 114, and a declarative memory module 115. Sub-modules may be included in each core module 111, 112, 113, 114, and 115. For example, the perception module 111 may include sub-modules related to spatial anchor detection, object detection, and speech recognition.

As used herein, ‘module’ may refer to software or program instructions to be executed by a controller, computer, data processor, memory, a combination of hardware electronics and software, or any arrangement or configuration that is capable of performing a particular referenced function.

Referring again to FIG. 1, the working memory module 113 integrates the information coming in from other modules and produces a speech output. Stated differently, the conversational navigational guidance and interaction with objects emerge from the interplay of all the modules through the working memory module 113, which provides global communication in the system 100. The working memory module 113 locally stores the situational context of the interaction into specialized buffers, for instance, the current navigational route and waypoint, the conversational history, objects' and anchors' spatial information, the user's current position, already visited waypoints and past and current actions. The contents of the working memory module 113 decay in proportion to their salience.

The system's behavior is organized around a cognitive cycle driven by the procedural memory module 114, with complex behavior (e.g., reasoning, planning, etc.) emerging as cascading sequences of such cycles. In each cognitive cycle, the system 100 senses the current situation, interprets it with respect to ongoing goals, and then selects an internal or external action in response. Thus, a cognitive cycle initiates when the perception module 111 processes both internal and external information that is stored in the working memory module 113. The procedural memory module 114 decides what to do next by retrieving the contents of the working memory module 113, which in turn retrieves knowledge about the user and the environment. Based on the output from these modules, a conversation action is processed by the motor module 112. In FIG. 1, arrows denote a flow of information between the different components of the system 100.

External and internal information provided to the system can include conversational ‘intents’, which are the goals or the aims that either the user or the system is conveying in an utterance. The intents can provide information (INFORM), request new information from the other interlocutor (ASK), request the other interlocutor to perform an action (REQUEST), or confirm (CONFIRM) or deny (DENY) a yes/no question. Conversational intents along with the conversational context and entities are used to guide the decision-making process of the system 100 at every conversational turn.

‘Intents’ may include ‘request-guidance’ (i.e. the user indicates the place/destination where they want to be guided); ‘request-guidance-with-context-info’ (i.e. the user indicates the place/destination where they want to be guided and the system 100 provides navigational instructions for a path as well as context-dependent information, such as objects or places nearby); ‘request-recommendation’ (i.e. the user indicates the type of store they want to visit and the system 100 generates recommendations based on the context of the conversation); ‘request-recommendation-alter-purchases’ (i.e. the user indicates the shopping store where they want to be guided and the system 100 provides opportunistic recommendations based on the similarity between the destination and other shopping stores nearby); ‘request-recommendation-multiple-destinations’ (i.e. the user indicates the type of store they want to go and the system generates recommendations based on the context of the conversation; if there are multiple stores that match the search criteria, then the system 100 generates a path with multiple stops); ‘request-item-comparison’ (i.e. the user requests the system 100 to compare a specific object/item with similar objects/items by using a picture of the item); ‘request-echolocate-object’ (i.e. the user pans the device's 110 camera over a room or place and the system 100 emits an increasing rate beep when the object is detected in the center of the screen of the device 110, creating an echo location effect); ‘request-look-around’ (i.e. the user pans the camera of the device 110 over a room or place and the system 100 describes and adds to information in the working memory module 113 all the objects detected by the object recognition sub-module of the perception module 111); ‘request-search-object’ (i.e. the user asks whether an object is in the room, then they pan the camera of the device 110 over a room or place and the system 100 confirms whether the object is there; if so, the system 100 provides the relative location and distance from the user location); ‘inform-visit-all-places’ (i.e. the user confirms that they want to visit multiple places as part of their path (e.g. the restroom, stores, the food court, etc.)); ‘inform-item-to-purchase’ (i.e. the user provides additional information about the item they want to purchase); or ‘request-guidance-with-replan’ (i.e. the user requests guidance to a destination that has multiple routes associated; the system 100 replans a new route if the current route is blocked or crowded).

Other information processed by the system 100 include a ‘chunk’ of information or knowledge. A ‘chunk’ is a piece of information that describes the features of an object or an anchor, which can be stored and exchanged across components of the system 100. For example, the working memory module 113 may include chunks of information, where each chunk may include one or more labels, is a set of structured slot-value pairs of arbitrary depth, has a recency clock, describes an intent of the user, and is indexed. A spatial anchor may also be a chunk. The declarative memory module 115 may contain factual information about the world (i.e. immediate environment) recorded as chunks. Such chunks may include information about locations, stores, products, inventories, sales, and similar domain knowledge. By way of further example, a ‘chunk’ could include the following information: chunk-id—chunk-store-001; category—place; subcategory—store; name—Macy's; timestamp—123456789.

Information may also include an ‘event’. An event is a situation that happens in a certain interval of time and it can be referred to during a conversation between the user and the system 100. Events are used to build the context of the conversation by associating expected objects and people in the scene, places, actions performed by people, and similar events. Some examples of events are a show, a medical appointment, boarding a plane, meeting an Uber, and getting a subway. By way of further example, an ‘event’ could include the following information: event-name—boarding-a-plane; airline—AA; gate—D38; date—Jan. 12, 2024; boarding time—3:15 PM; flight time—4:15 PM; people—passenger, check-in-agent; objects—luggage, check-in desk, passport; places—wait room, airplane, shops.

Additionally, a ‘relatedness metric’ can be used to determine how related a spatial anchor is to the contents/chunks of the working memory module 113. In one example, the spatial anchor has the same key-value pair structure defined by chunks. Thus, the relatedness is based in part on repeated key-value pairs in each of the chunk and spatial anchor.

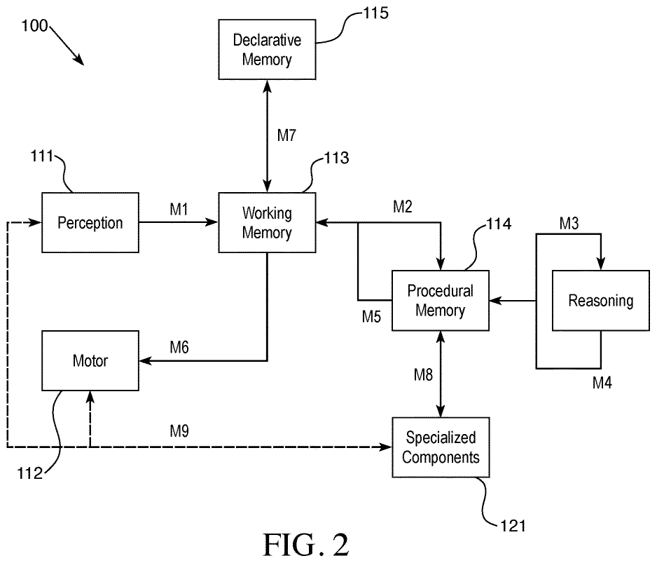

FIG. 2 is an alternative representation of the architecture of the system 100, with arrows depicted messages or interactions between the components of the system 100. As shown in FIG. 2, the system 100 may include specialized components 121. These specialized components 121 may include modules or sub-modules related to echo-location, wayfinding, recommendation engine, and an advertising engine. By way of further example, a specialized component 121 can be used in an interaction that is faster than a cognitive cycle of the system 100 and is used for a specific purpose, such as echo-echolocation. In this example, the specialized component 121 can be used for object detection to determine an object's bounding box. The system 100 then uses other sensors (i.e. AR and LiDAR) to focus on the bounding box to determine the object's position in the real world. In one example, the specialized components 121 may comprise an external access component that links to the procedural memory module 114.

The system 100 depicted in FIGS. 1-2 resembles the structures and processes found in human cognition. This type of system 100 prioritizes bounded rationality over optimality, enabling the system 100 to compensate for limited resources by selectively filtering and processing continuous streams of data. This feature can improve performance when the electronic device 110 on which it is implemented has limited resources. Further, the interaction among the cognitive components facilitates emergent control and orchestration of object detection, spatial anchors, and conversation.

The following will describe in greater detail the flow of information between modules and the functions performed by each module. First, the perception module 111 yields an output which may include symbol structures (percepts) with associated metadata in specific working memory buffers. The module 111 perceives the environment through three components: speech recognition, object detection, and spatial anchor detection. Speech recognition perceives spoken words and emits a text transcription. Object detection performs realtime multi-object detection and tracking by using a live camera feed, for example. In one embodiment, the system 100 can use mobile app-optimized off-the-shelf APIs for computer vision and leverage a pre-trained image classification model that recognizes object labels and categories, such as food, furniture, home/office appliances, building parts, and people.

For each detected object, object detection can return a set of labels, a confidence score per label, and a bounding box representing the location of the object on the screen. Spatial anchor detection recognizes augmented reality spatial anchors, that is, 3D models that represent points of interest that can have attached virtual content. Spatial anchors rely on an AR framework to perceive the environment and track the device's 110 movement, position, and orientation. The AR framework uses visual-inertial odometry, a technique that combines information from the device's 110 motion-sensing hardware (e.g., compass, accelerometer, LiDAR scanner) with computer vision analysis of the scene visible to the device's 110 camera. A typical percept generated by the perception module 111 has the following structure:

(perceives, speech_recognition, Where is the fridge?)
(perceives, object_detection, [(microwave, pos1)...])
(perceives, spatial_anchors, [(fridge, pos2), ...])

The system 100 may rely on an external database to store both localization/recognition information of spatial anchors (e.g., position, surrounding objects used as context, etc.) and the content of the spatial anchors (e.g., description, properties, etc.). Anchor content creation is described herein as ‘instrumentation’. In one example embodiment, the instrumentation process leverages Microsoft Azure ASA as its spatial anchor technology, complemented by Apple's augmented reality engine ARKit. ARKit facilitates the perception of the user's surroundings and effectively tracks the device's movement, position, and orientation. Furthermore, ARKit incorporates visual-inertial odometry, merging data from the device's motion-sensing hardware with computer vision analysis to achieve precise localization of anchors' positions and orientations at the centimeter scale.

The instrumentation process allows the placement of spatial anchors as 3D models in real-world space that can be positioned, tracked, and stored in the cloud. The system 100 may rely on four different types of spatial anchors: navigation anchors (e.g., waypoints), points of interest (POI) anchors (e.g., a lounge area), destination anchors (a special type of POI), and interaction anchors (e.g., doors). Anchor content is represented as semantic key-value pairs, such as [<object: door>, <material: glass>, <position-handle: right>, <how-to-open: pull>]. In the context of a building, a trained individual could instrument the space by creating one or several sessions. Each session consists of a set of linked anchors that enable navigation and interaction. Waypoint anchors are linked to other waypoint anchors, POI anchors, and destination anchors, while interaction anchors are linked to POI anchors.

The motor module 112 converts symbolic relational structures in the working memory module 113 into output actions (e.g., speech synthesis; visual displays of graphics, image, or video; haptic actions; sound effects). For example, the motor module 112 provide wayfinding speech actions like “walk ten feet and turn to your left”, answering question actions, providing recommendations, and other similar actions. Thus, in this context, motor symbol structures have the same syntax as the percepts in the perception module 111, however, instead of representing features of the perceived objects (as percepts do), motor symbol structures tells what kind of actions need to be performed.

Speech synthesis sets two different speech rates: normal (1.0×) for conversational interaction, such as answering user questions, and fast (2.0×) for providing navigational instructions, like “walk 5 steps forward”. This design aligns with the common practice in speech synthesis for people who are blind or low-vision, who adapt to accelerated speech in scenarios where the discourse involves a familiar set of sentences with minor variations, facilitating easy recognition. In the case that the speech is novel, a lower speed is used to ensure comprehension of the audio. A typical symbolic structure processed by the motor module 112 is as follows:

(utters, system, “The microwave is in front of you”)
(is_type, output, question_answering)
(has, speech_rate, 1.0)

The conversational proxy 120 on the device 110 in combination with the large language model (LLM) 124 hosted on the server 109 interprets the intentions that the user conveys and provides assistance conversationally. By way of further example, the conversational proxy 120 formats the content of the working memory module 113 so the LLM 124 can better process the prompt/input, and then, when the LLM 124 has produced an output, it transforms the LLM's output back as a working memory chunk. Thus, the proxy 120 structures the contents of the working memory module 113 in a specific format and prompts the LLM 124 to generate an output that is then stored back into the working memory module 113.

In one embodiment, the LLM 124 is fine-tuned to encode a set of 12 special tokens, which serve as delimiters and segment indicators. The concatenated segments are:

<bos><user> do you see a microwave?
<history> user: hi. sys: hi, how can I help you?
<objects> (table, left), (microwave, in-front)
<distance> far-from-waypoint
<angle> 1 o'clock
<planner> turn-slightly-right
<intent> search-object
<entity> microwave
<call> is_perceived(microwave): bool
<output> Yes, I see a microwave in front of you <bos>

Special tokens <bos> and <eos> indicate the beginning and end of the sequence, respectively. <user> denotes the most recent user's utterance, <history> contains the most relevant conversational history stored in the working memory, <objects> is a list of perceived objects and anchors and their relative position in the real world, and <distance> and <angle> correspond to the current orientation of the user with respect to the next waypoint (anchor) in the path. <planner> is the next navigational step generated by the path planner. <intent> and <entity> are the dialogue intent and entities extracted from the user's utterance, respectively. <call> is an internal invocation to retrieve content from a specific buffer in the working memory. <output> is either a navigational instruction or an answer to a question. When prompting the LLM 124, the subsequence <bos> . . . <intent> is used as an input, so the LLM 124 generates the rest of the sequence providing an intent, list of entities, a call (if any), and a speech output.

The LLM 124 can generate the inputs/outputs of three main components resembling the execution of a pipelined spoken dialogue system. The execution pipeline starts with a natural language understanding component (or sub-module) 126 that leverages the LLM 124 to process the prompt generated by the conversational proxy and classify a set of both user intents (listed in Table 1) and entities.

TABLE 1
Example of a User User Intent (NLU) System Intent Example of a system

| Utterance | | (NLG) | Utterance |
|---|---|---|---|
| Take me to | request-route | navigate | Walk 5 steps and open |
| the kitchen | | | the door |
| | | interact | Open the glass door in |
| | | | front of you |
| Tell me what | look-around | list-objects | I see a door, a table, and |
| you see | | | two chairs |
| Do you see | search-object | confirm-obj- | Yes, I see a fridge 3 feet |
| any fridge? | | found | away on your left |
| Do you recall | recall-obj-pos | provide- | The fridge is 6 feet away |
| where the | | obj-pos | behind you |
| fridge is? | | | |
| Is there any | search- | confirm-empty- | There's an empty chair |
| available | empty-seat | seat | 10 feet in front of you |
| seat? | | | |
| Echolocate | echolocate | provides- | (beep) . . . The laptop is 5 |
| a laptop | | obj-pos | feet in front of you |
| Read water | request-read | read-label | 500 ml . . . mineral |
| bottle's label | | | water . . . |

Then, the dialogue manager component (or sub-module) 125 of the LLM controls the conversation flow, tracks user information, and builds conversational context via the working memory module 113 by performing a two-step process. First, the dialogue manager 125 takes the outputs from the natural language understanding component 126 along with the conversational history and prompts the LLM 124 to generate both a dialogue state (containing a goal constraint, a set of slots/values, and the dialogue act) and a function call signature that maps the slots/values in the dialogue state onto arguments of a function call that retrieves specific contents from the working memory module 113 (e.g., object detection). As a second step, the dialogue manager 125 injects the results from the function call into the pipeline, and the LLM 124 is prompted again to generate a set of intents/actions that the system should perform in the current conversational turn.

Finally, a natural language generator component (or sub-module) 127 dynamically converts the system intents generated by the dialogue manager 125 into natural language text. To that end, the LLM 124 maps the system intents onto natural language templates, and then it replaces text placeholders with information stored in the working memory module 113. The generated text is then synthesized by the speech synthesis sub-module 134 of the motor module 112.

As a backup feature, when the device 110 cannot communicate with the server 109 due to internet connection issues (e.g., inside an elevator), the conversational proxy 120 uses on-device natural language processing libraries for sentence embeddings and entity recognition to locally recognize user's intents while the connection with the LLM 124 is reestablished.

The procedural memory module 114, or long-term memory module, exerts global control by modifying the contents of the working memory module 113 through the activation of rules. The rules can trigger the retrieval of contents from the declarative memory module 115, set new system goals, invoke external systems like the conversational components 120, 121, 124, and perform other similar functions.

For instance, a set of rules is used to filter the objects perceived by the system 100 and assign the most representative classification label. As mentioned before, each object is classified into one or multiple labels, exhibiting a wide range of detail levels, with higher confidence assigned to the more general labels. Hence, the set of rules below determines the most suitable label for each perceived object:

```
1. if !working_memory.retrieve(obj).empty
  then label ← working_memory.retrieve(obj).label
2. elif perception.get(obj).labels == 1
  then label ← perception.get(obj).labels[0].label
3. elif max(...labels.confidence) > 0.5
  then label ← min(filter(labels.confidence > 0.5))
4. elif max(...labels.confidence) <= 0.5
  then label ← max(...labels.confidence > 0.5)
```

Stated differently, in the rules shown above, the if the object was previously detected (via tracking), then—use the corresponding label stored in the memory module 113, else if—only one label is generated by the classification model, then—use that single label, else if—there are labels with confidence scores >0.5, then—pick the label with the lowest confidence score (specific label), else if—there are labels with confidence scores <=0.5, then—use the label with the highest confidence score (abstract label). For example, with labels [(furniture: 0.98), (chair: 0.65), (loveseat: 0.38)] for a perceived object, the object detection module selects the label “chair” (production 3) as the best description.

Additionally, a set of procedural rules prescribes the execution priority of the system's audio and speech output and decides whether a process must be interrupted to make way for another one. For instance, the non-verbal audio feedback that signals the user when they need to reorient their position has the lowest priority. The next priority level corresponds to the verbal turn-by-turn navigational instructions. Next, the mechanism that verbally lists all the detected objects when requested by the user has a higher priority level. Finally, answers to the user's questions have the highest priority. Another subset of rules is in charge of pausing speech synthesis if speech recognition is running simultaneously, then, speech synthesis is resumed after speech recognition is done. As a result, the motor module 112 adds system actions to a queue so they are executed in a particular order.

The declarative memory module 115 is separated into semantic and episodic memories. The former maps to semantically abstract facts, while the latter maps to contextualized experiential knowledge. Semantic memory stores both the user's navigational preferences (e.g., speech rate and volume, distance units, etc.) and each spatial anchor's virtual content as semantic chunks, for instance: (chunk1, door, (material: glass, opens: push, handle: panic exit bar)). The episodic memory stores past user interactions with the system to enhance the personalization of navigation for previously visited places.

Using the inputs from sensors and hardware on the device 110, the AR indoor localization module 116 infers and generates a 3D sparse point-cloud map or representation of the environment, and, by matching the point-cloud map against the feature points generated in realtime by a camera on the device 110, for example, it provides a way for the device 110 to recognize spaces and precisely localize its position and orientation within that space, with accuracy typically at the centimeter scale.

Once spatial anchors for waypoints are placed in the real world and persisted in the server 109, a weighted graph is built representing how waypoints are connected to each other, where the cost of each edge corresponds to the distance between waypoints, or some other desirability metric (e.g. expected profit). Next, during execution, the path planner module 117 uses a path planning algorithm to determine the optimal path for the user to follow.

In one example embodiment, the device 110 comprises an Apple iPhone 13 Pro equipped with iOS 16, an A15 Bionic processor (16-core neural engine, 6-core CPU, and 5-core GPU), 256 GB of memory, a TrueDepth camera, three rear cameras, and a LiDAR scanner. This hardware configuration allows on-device machine learning models for object/person detection to be performed with high accuracy, and the localization of spatial anchors to be accurately determined.

With respect to the software technologies in this example, both speech recognition and speech synthesis use the core framework delivered with iOS. The perception module 111 (for object/person detection) harnesses the power of Google's MLKit, an on-device framework for computer vision. An image classification model pre-trained on TensorFlow that can recognize up to 630 object labels and 37 categories can be used. As frameworks for augmented reality and spatial anchors, the system 100 uses ARKit and Azure Spatial Anchors, respectively. For the conversational proxy 120, the system 100 uses a GPT-2 LLM model using a synthetically-generated dataset of 1K conversations, and values for Adam learning rate (5.75e-5), epsilon for Adam optimizer (1e-8), top-p nucleus sampling (0.95) and top-k sampling (50). Alternatively, the system can utilize ChatGPT (GPT-4) for some processes.

In one example application of the system 100, the user can initiate a conversational wayfinding task by asking “how do I get to Footlocker?”. In this example, spatial anchors and wayfinding are used concurrently to perform the task. With the store as the spatial anchor, the wayfinding process will be presented to the user as conversational instructions. For example, after the user requests how to get to the location, the system 100 will say “walk forward five steps”. After the user completes the five steps, the system will continue by saying “turn left”. The wayfinding process continues for each leg of the route, until the user arrives at the location.

In this example, the user speaks the request with normal conversational speech. The request is sent from the perception module 111 to the conversational system (such as LLM 124) and the resulting wayfinding intent chunk (i.e. request-guidance) containing the destination is inserted into the working memory module 113 via pathway M1 (see FIG. 2). The intent chunk invokes the following wayfinding procedure: (1) the destination is ground in a spatial anchor; (2) if the destination can not be grounded, it can be disambiguated by performing reasoning via pathways M3 and M4; (3) the user's current location is ground in a spatial anchor as the start; (4) a production rule from the procedural memory module 114 is triggered and its action call the path planning module 117 to generate a path of spatial anchor points from the destination to the start via pathways M2, M8, and M5; (5) natural language directions are generated and sent to the user via M9; when the user arrives at an intermediate location, the directions are updated; (6) the process in step (5) is repeated until the user arrives at the destination; and (7) the place visited (anchors, path, objects detected, etc.) are stored in the declarative memory module 115 for future reference via M7.

In another application example, the user can be provided context-dependent information in addition to the wayfinding instructions. For example, the user can ask “how do I get to Footlocker?”. The system 100 would provide wayfinding instructions at detailed above and would also say “On the way, you might stop at Macy's”. This additional information is added to the trip, similar to an advertisement. To provide the context-dependent information, the system 100 retrieves content from the working memory module 113 via M2 relevant to the current context (e.g., user intent, destination, destination type, location, time, etc.). The selected content is compared to the closest spatial anchors using a relatedness metric. For instance, if the type of destination is a shoe store and there is a nearby spatial anchor attached to a location of the same type (e.g., Macy's), or if the current time is noon and there is a spatial anchor attached to a restaurant, then select those related spatial anchors.

In another application example, the user can be provided conversational wayfinding in addition to shopping recommendations. For example, if the user says, “I want to buy shoes and get something to eat”, the system 100 can reply “I recommend Footlocker, and on the way, you can get a burrito at Taco Bell”. If the user responds “OK”, the system 100 will provide wayfinding instructions for multiple stops. The process starts with the request, which the system 100 identifies as a natural language request containing multiple goals. The request is sent to the conversational system via M9 and the resulting intent (request-recommendation) and chunks corresponding to the goals are inserted to the working memory module 113. The system 100 then searches for spatial anchors that match to the intent chunks and ranks the spatial anchors based on some criteria, such as proximity or relevance. The process is repeated until either the destination for an intent is agreed upon by the user or no more anchors are available. The intent chunks will invoke the wayfinding procedure via production rules via M2 and M5. After completion, the system 100 will store the visited place (i.e. anchors, path, objects detected, etc.) in the declarative memory module 115 for future reference.

In another application example, the user can be provided conversational recommendations in a shopping mall with alternative purchases. In this example, the user will say, “I want to go to Footlocker”. The system will respond by saying, “Start by walking ten feet. By the way, Macy's has a sale on shoes and it's on the way to Footlocker”. Here, there is an alternative to an existing goal. The request in this application is converted into a wayfinding intent chunk (request-recommendation-alter-purchases) containing a destination. During the path planning process, the system 100 will compare selected content and the closest spatial anchors using a relatedness metric based on the type of destination. For example, if the type of destination is a shoe store and there is a nearby spatial anchor attached to a location of the same type, the those related spatial anchors are selected.

In another application example, the user can be provided conversational recommendations. For example, if the user says, “I want to buy shoes”, the system 100 will respond by stating, “There are five stores that sell shoes in the mall. What kind of shoes?”. The user can respond by stating, “I want shoes for a five-year-old child”. The system 100 will then revise the recommendation by stating, “There are three stores that sell children's shoes, do you want to visit all three or provide more information?”. If the user says. “visit all three”, the system 100 will provide wayfinding instructions. Here, the user request is converted into an intent chunk (request-recommendation-multiple-destinations) and inserted into the working memory module 113. Spatial anchors are searched until one that match the intent are found. The process is repeated until the intent has been agreed upon by the user.

In another application example, the user can be provided conversational comparison shopping in a shopping mall. For example, if the user says, “I found a nice sweater for $200 that fits me, here's an image of it”. The system 100 can respond, “A similar sweater is on sale for $100 at Macy's, a five-minute walk”. Here, the request is converted into an intent chunk (request-item-comparison) and inserted into the working memory module 113. The picture of the item is sent to the objection recognition sub-module of the perception module 111 and a set of labels of the object are returned and inserted into the working memory module 113. The labels can include: category—sweater; subcategory—turtleneck; color—red; and similar labels. The system 100 filters out the set of spatial anchors based on the intent and entities (i.e. clothing stores). The system 100 can connect to an external database of the store associated with the spatial anchor via pathways M2, M8, and M5. In this particular example, the results can be sorted by price, which are conveyed to the user in conversational speech. Once the user picks the store, wayfinding instructions are provided.

In another application example, the user can be provided wayfinding directions in addition to discovery results. For example, if a blind person is at the airport and has a 3-hour layover, they may decide to explore the environment. The process starts with the user asking, “tell me what I can visit around”. The system 100 responds by saying, “here are some options: there are restrooms, a food court, and shopping stores”. The user then selected a category by saying, “OK, let's visit first the shopping stores and then the food court.” The system 100 can respond by saying, “Sure, there are two souvenir stores, a jewelry store, and a duty-free store”. The user responds with “OK, let's go first to one of the souvenir stores”. The system 100 can further describe what is in the store and provide wayfinding instructions to particular items in the store. In this example, the request is converted to an intent chunk (request-look-around) and the system 100 searches for the closest anchors within a certain radius of the user's location. The main category or label of the spatial anchor is stored in the working memory module 113. Next, the system 100 provides a description of the spatial anchors using their relative position and distance. Once the user selects a store, wayfinding guidance is provided. At the store, the system 100 can provide a description of objects meeting search criteria.

In a final application example, the user can be provided alternative wayfinding instructions. For example, if the user asks, “how do I get to Footlocker”, the system can respond with “walk forward five steps”. If the object recognition sub-module of the perception module 111 detects that construction work is blocking the path, the system 100 will replan a new path. The new path is conveyed to the user with the instructions to “turn left”. Here, the request is converted into a wayfinding chunk (request-guidance-with-replan) with a destination stored in the working memory module 113. Wayfinding instructions are generated by the planning module 117, which may generate multiple paths. If the system 100 detects at any time that a path is blocked, the system 100 removes the current plan form the working memory module 113 via pathway M5. The system 100 reasons over the path graph to obtain an alternative path via pathways M2, M3, M4, and M5. A natural language notification is generated alerting the user about replanning a new route.

When used in this specification and claims, the terms “comprises” and “comprising” and variations thereof mean that the specified features, steps, or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure. Although certain example embodiments of the invention have been described, the scope of the appended claims is not intended to be limited solely to these embodiments. The claims are to be construed literally, purposively, and/or to encompass equivalents.

What is claimed is:

1. A method for providing navigation and interaction assistance comprising:
acquiring data about an object or an environment using a perception module;
storing the data in a working memory module, wherein the working memory module receives the data from the perception module and integrates the data with other information stored in the working memory module; and
providing output based on processing of the information, wherein the output comprises conversational speech.

2. The method of claim 1, wherein the perception module performs at least one of object detection, speech recognition, and spatial anchor detection.

3. The method of claim 1, wherein the output provides wayfinding in a shopping mall, medical facility, transportation facility, office building, or similar environment.

4. The method of claim 3, wherein the output further provides context-dependent information related to a route provided in the wayfinding.

5. The method of claim 2, wherein the output further provides recommendations based on a user input.

6. The method of claim 2, wherein the output further provides recommendations based on a user input and inferred user intent.

7. The method of claim 1, wherein a motor module generates the conversational speech.

8. The method of claim 1, wherein a procedural memory module drives a cognitive cycle using information stored in the working memory module, wherein the cognitive cycle produces a complex behavior related to planning, reasoning, or other complex tasks based on goals of a user.

9. The method of claim 8, wherein the goal comprises at least one of a request for guidance, a request for guidance with contextual information, a request for recommendation, a request for recommendation with for alternative options, a request for recommendation with multiple destinations, a request for item comparison, a request to locate an object, a request to look around, a request to search for an object, and a request for guidance with an alternative route.

10. The method of claim 1, wherein the information comprises a description of the features of an object or a spatial anchor.

11. The method of claim 10, wherein the information further comprises a set of structured slot-value pairs, a recency clock, describes a goal of a user, and is indexed.

12. The method of claim 1, wherein a declarative memory module stores factual information about an external environment or objects located in the external environment.

13. The method of claim 12, wherein the external environment or objects located in the external environment includes at least one of a location, a store, a product, inventory, pricing, and similar information.

14. The method of claim 1, wherein information comprises an event comprising a situation that occurs in a certain time interval.

15. The method of claim 1, further comprising processing speech requests from a user on a large language model stored on an external device.

16. A system for providing navigation and interaction assistance comprising:
an electronic device adapted perform the following functions:
acquiring data about an object or an environment using a perception module;
storing the data in a working memory module, wherein the working memory module receives the data from the perception module and integrates the data with other information stored in the working memory module; and
providing output based on processing of the information, wherein the output comprises conversational speech.

17. The system of claim 16, wherein the electronic device comprises a smartphone have at least one sensor selected from the group consisting of an optical camera, a light detection and ranging scanner, and a depth camera.

18. The system of claim 16, further comprising:
an external database in communication with the electronic device.
